(19) United States
(12) Patent Application Publication
(10) Pub. No.: US 2026/0139523 A1
(43) Pub. Date: May 21, 2026

(54) VEHICLE LATCH WITH OPEN ASSIST

(71) Applicant: Inteva Products, LLC, Troy, MI (US)

(72) Inventors: Hector Sanchez Rojas, Ciudad Juarez (MX); Pedro Alfredo Alvarado Heredia, Ciudad Juarez (MX); Donald Michael Perkins, Rochester Hills, MI (US); Ari Yussel Mino Ramirez, Ciudad Juarez (MX)

(21) Appl. No.: 19/381,223

(22) Filed: Nov. 6, 2025

Related U.S. Application Data
(60) Provisional application No. 63/722,058, filed on Nov. 18, 2024.
(60) Provisional application No. 63/724,061, filed on Nov. 22, 2024.

(51) Int. Cl. E05B 81/20

(52) U.S. Cl. CPC E05B 81/20

(57) ABSTRACT

A vehicle latch assembly, including: a remote cinching actuator; and a vehicle latch, the vehicle latch including: a latch housing; a claw pivotally mounted to the latch housing; and a cinch lever pivotally mounted to the latch housing, wherein rotation of the cinch lever by the remote cinching actuator will rotate the claw into a closed position or rotate the claw into an open position.

### CROSS REFERENCE TO RELATED APPLICATIONS

This application claims the benefit of U.S. Provisional Ser. No. 63/722,058 filed on Nov. 18, 2024 and U.S. Provisional Ser. No. 63/724,061 filed on Nov. 22, 2024, the entire contents each of which are incorporated herein by reference thereto.

### BACKGROUND

Exemplary embodiments of the present disclosure pertain to the art of vehicle latches.

The automotive industry is often evolving and prioritizing safety, reliability and efficiency, driving closure systems to deliver state-of-the art technologies capable of meeting these key points to ensure customer satisfaction. The current closures face different challenges such as sound quality, trustworthiness and durability, which can detract form the overall vehicle and customer experience. The closure system/mechanism presented herein introduces enhanced features that align with the market trends for premium vehicles while still being compliant with evolving regulatory standards, improving the competitiveness of not only the closure but also of the vehicle itself.

In a vehicle door latch with a power release mechanism, the associated vehicle door sometimes does not transition from latched position to an open position this may be due to the vehicle door being frozen to the opening the vehicle door is secured to. This may be caused by moisture located between the seals of the door and the vehicle body that freezes in cold temperatures.

As such and having the ability of unjamming the vehicle door under extreme freezing conditions has become a real need in the market. For side door latches, ice might build up around the door, making it difficult for the passenger to pull the handle and open the door. As such, it is desirable to provide the latch assembly with a mechanism that will be capable of assisting in the opening of the vehicle door, making it easier to enter their vehicle under extreme cold temperatures.

### BRIEF DESCRIPTION

Disclosed is a vehicle latch assembly, including: a remote cinching actuator; and a vehicle latch, the vehicle latch including: a latch housing; a claw pivotally mounted to the latch housing; and a cinch lever pivotally mounted to the latch housing, wherein rotation of the cinch lever by the remote cinching actuator will rotate the claw into a closed position or rotate the claw into an open position.

Also disclosed is a vehicle latch, the vehicle latch including: a latch housing; a claw pivotally mounted to the latch housing; and a cinch lever pivotally mounted to the latch housing, wherein rotation of the cinch lever will rotate the claw into a closed position or rotate the claw into an open position.

Also disclosed is a vehicle latch assembly, including: a remote cinching actuator; and a vehicle latch, the vehicle latch including: a latch housing; a claw pivotally mounted to the latch housing; a cinch lever pivotally mounted to the latch housing, wherein rotation of the cinch lever by the remote cinching actuator will rotate the claw into a closed position or rotate the claw into an open position; and an open assist lever pivotally secured to the cinch lever the open assist lever has a channel or opening configured to engage a feature or pivot of the claw of the vehicle latch.

In addition to one or more of the features described above, or as an alternative to any of the foregoing embodiments, the vehicle latch further includes: an open assist clutch lever and wherein the open assist lever has a guide pivot operably coupled to the open assist clutch lever.

In addition to one or more of the features described above, or as an alternative to any of the foregoing embodiments, the vehicle latch further includes: a bellcrank override lever operably coupled to the open assist clutch lever.

In addition to one or more of the features described above, or as an alternative to any of the foregoing embodiments, the vehicle latch further includes: a cinch link pivotally secured to the cinch lever, the cinch link contacting the claw during a cinching operation of the vehicle latch.

In addition to one or more of the features described above, or as an alternative to any of the foregoing embodiments, the cinch link further includes a bearing that makes contact with an override lever of the vehicle latch.

In addition to one or more of the features described above, or as an alternative to any of the foregoing embodiments, rotation of the cinch lever during a cinching operation causes the cinch link to contact the claw and rotate the claw into the closed position.

In addition to one or more of the features described above, or as an alternative to any of the foregoing embodiments, rotation of the cinch lever during an open assist operation causes the cinch link to not contact the claw and the open assist lever will engage the feature or pivot of the claw via the channel or opening of the open assist lever in order to rotate the claw into the open position.

In addition to one or more of the features described above, or as an alternative to any of the foregoing embodiments, the cinch link further includes a bearing that makes contact with an override lever of the vehicle latch.

In addition to one or more of the features described above, or as an alternative to any of the foregoing embodiments, rotation of the cinch lever during a cinching operation causes the cinch link to contact the claw and rotate the claw into the closed position and the open assist lever does not contact the claw.

Also disclosed is a vehicle latch, the vehicle latch including: a latch housing; a claw pivotally mounted to the latch housing; a cinch lever pivotally mounted to the latch housing, wherein rotation of the cinch lever will rotate the claw into a closed position or rotate the claw into an open position; and an open assist lever pivotally secured to the cinch lever the open assist lever has a channel or opening configured to engage a feature or pivot of the claw of the vehicle latch.

In addition to one or more of the features described above, or as an alternative to any of the foregoing embodiments, further including an open assist clutch lever and wherein the open assist lever has a guide pivot operably coupled to the open assist clutch lever.

In addition to one or more of the features described above, or as an alternative to any of the foregoing embodiments, further including: a bellcrank override lever operably coupled to the open assist clutch lever.

In addition to one or more of the features described above, or as an alternative to any of the foregoing embodiments, further including: a cinch link pivotally secured to the cinch lever, the cinch link contacting the claw during a cinching operation of the vehicle latch.

In addition to one or more of the features described above, or as an alternative to any of the foregoing embodiments, the cinch link further includes a bearing that makes contact with an override lever of the vehicle latch.

In addition to one or more of the features described above, or as an alternative to any of the foregoing embodiments, rotation of the cinch lever during a cinching operation causes the cinch link to contact the claw and rotate the claw into the closed position.

In addition to one or more of the features described above, or as an alternative to any of the foregoing embodiments, rotation of the cinch lever during an open assist operation causes the cinch link to not contact the claw and the open assist lever will engage the feature or pivot of the claw via the channel or opening of the open assist lever in order to rotate the claw into the open position.

In addition to one or more of the features described above, or as an alternative to any of the foregoing embodiments, the cinch link further includes a bearing that makes contact with an override lever of the vehicle latch.

In addition to one or more of the features described above, or as an alternative to any of the foregoing embodiments, rotation of the cinch lever during a cinching operation causes the cinch link to contact the claw and rotate the claw into the closed position and the open assist lever does not contact the claw.

Also disclosed is a method of opening and closing a vehicle latch of a vehicle latch assembly, including: actuating a remote cinching actuator of the vehicle latch assembly during an open assist operation of the vehicle latch when a pawl of the vehicle latch is in a disengaged position with respect to a claw of the vehicle latch and the claw of the vehicle latch is in a closed position; actuating the remote cinching actuator of the vehicle latch assembly during a cinching operation of the vehicle latch in order to rotate the claw of the vehicle latch into the closed position; wherein actuation of the remote cinching actuator during the cinching operation of the vehicle latch or the open assist operation of the vehicle latch causes a cinch lever of the vehicle latch to rotate in a first direction; wherein rotation of cinch lever in the first direction during the cinching operation of the vehicle latch will cause a cinch link pivotally secured to the cinch lever to contact the claw and rotate the claw into the closed position; wherein rotation of cinch lever in the first direction during the open assist operation of the vehicle latch will cause an open assist lever pivotally secured to the cinch lever to engage a feature or pivot of the claw of the vehicle latch with a channel or opening of the open assist lever; and wherein the open assist lever does not contact the claw during the cinching operation of the vehicle latch and the cinch link does not contact the claw during the open assist operation of the vehicle latch.

In addition to one or more of the features described above, or as an alternative to any of the foregoing embodiments, the open assist lever has a guide pivot operably coupled to an open assist clutch lever of the vehicle latch and the cinch link further comprises a bearing that makes contact with an override lever of the vehicle latch, the guide pivot determining a position of the open assist lever and the bearing determining a position of the cinch link.

### BRIEF DESCRIPTION OF THE DRAWINGS

FIG. 1 is a view of vehicle latch assembly in accordance with the present disclosure;

FIG. 2 is a perspective view of a vehicle latch in accordance with the present disclosure;

FIG. 3 is a view of interior components of a vehicle latch in accordance with the present disclosure;

FIG. 4 is an exploded view of some of the interior components of a vehicle latch in accordance with the present disclosure;

FIG. 5 is a view of interior components of a vehicle latch in accordance with the present disclosure;

FIG. 6 is a perspective view of a housing of the vehicle latch in accordance with the present disclosure;

FIG. 7 is a view illustrating a claw and a pawl of the latch in an open position;

FIG. 8 is a view illustrating the claw and the pawl of the latch in a secondary position;

FIG. 9 illustrates components of the vehicle latch in the secondary position without the latch housing;

FIG. 10 illustrates components of the vehicle latch without the latch housing;

FIG. 11 is an enlarged portion of FIG. 10;

FIG. 12 is a cross-sectional view of FIG. 11;

FIG. 13 illustrates components of the vehicle latch without the latch housing;

FIG. 14 is a cross-sectional view of portions of FIG. 15;

FIG. 15 illustrates components of the vehicle latch without the latch housing;

FIG. 16 is a cross-sectional view of portions of FIG. 15;

FIG. 17 illustrates a cinch mechanism of the vehicle latch in a home position;

FIG. 18 illustrates operation of a cinch mechanism of the vehicle latch in accordance with the present disclosure;

FIG. 19 is partial cross-sectional view of components illustrated in FIG. 18;

FIG. 20 illustrates movement of components of the cinch mechanism in accordance with the present disclosure;

FIGS. 21 and 22 illustrate operation of a cinch mechanism of the vehicle latch in accordance with the present disclosure;

FIG. 23 illustrates components of the cinch mechanism in accordance with the present disclosure;

FIG. 24 illustrates the cinch mechanism in a home position in accordance with the present disclosure;

FIGS. 25 and 26 are partial cross-sectional views of the view illustrated in FIG. 24;

FIG. 27 illustrates the cinch mechanism in a first transition position or cinching transition 1 in accordance with the present disclosure;

FIGS. 28 and 29 are partial cross-sectional views of the view illustrated in FIG. 27;

FIG. 30 illustrates the cinch mechanism in a second transition position or cinching transition 2 in accordance with the present disclosure;

FIGS. 31 and 32 are partial cross-sectional views of the view illustrated in FIG. 30;

FIG. 33 illustrates the cinch mechanism in a third transition position or cinching transition 3 in accordance with the present disclosure;

FIGS. 34 and 35 are partial cross-sectional views of the view illustrated in FIG. 33;

FIG. 36 illustrates the cinch mechanism in a full travel transition position in accordance with the present disclosure;

FIGS. 37 and 38 are partial cross-sectional views of the view illustrated in FIG. 36;

FIG. 39 illustrates the cinch mechanism in accordance with the present disclosure;

FIGS. 40-46 illustrates the override feature of the vehicle latch in accordance with the present disclosure;

FIGS. 47-53 illustrates the override feature of the vehicle latch in accordance with the present disclosure;

FIGS. 54 and 55 illustrate the vehicle latch in the release position with the open assist enabled;

FIGS. 56 and 57 are partial cross-sectional views of views illustrated in FIGS. 54 and 55;

FIGS. 58-61 illustrate opening assist transitions; and

FIGS. 62 and 63 illustrate operation of the open assist in accordance with the present disclosure.

### DETAILED DESCRIPTION

A detailed description of one or more embodiments of the disclosed apparatus and method are presented herein by way of exemplification and not limitation with reference to the attached Figures.

A mechanism capable of cinching from secondary to primary closed position, overriding the cinching function and an open assist feature which may be used to break ice to release the claw.

The mechanism includes an overmolded cinching lever that is attached to a cinch link which contacts the claw to reach primary closed position during the cinching operation. This cinch link is also connected to a bearing which follows a channel on an override lever to reach the cinching position.

The cinching function can be overridden through a manual release or power release operation. By initiating a release operation, the release lever will interact with an override bell crank or bell crank override to disengage an override clutch lever, allowing the override lever to move since its position will determine the bearing travel to either the overridden or cinching position. During this operation, the bearing path restricts the interaction between the claw and the cinch link, halting it from reaching primary closed position.

In addition, the cinching mechanism can be configured to integrate an opening assistant/ice breaker for climates with low temperatures, prone to ice accumulation/build-up. The ice breaker is only activated when the latch senses the pawl switch when releasing, but fails detect the claw, indicating that it has become jammed. To unbind the claw, the vehicle will perform a power release actuation to maintain a hold open position. In this situation, the release lever will contact the override bell crank or bell crank override which is joined to an ice breaker clutch lever through a pin on the former, traveling through a channel on the latter. The ice breaker clutch lever restricts a spring-loaded ice breaker link, so by moving the clutch lever, the ice breaker spring will act to move the ice breaker link and engage a stud located on the claw to move it to the open position.

Described below are some features that allow this mechanism to be functional and unique.

During the ice-breaker operation, the override bell crank will maintain the clutch lever in the override position to prevent a binding condition between the ice breaker and the cinch override components. It should be noted that the override bell crank does not move during the cinching operation.

The ice breaker link contains a pin that follows the override clutch lever. This mechanical relationship ensures that the clutch lever movement directly influences the action of the ice breaker link. Thanks to this feature, the ice breaker link maintains its home position during the cinching actuation, preventing a collision between the claw stud and the pin on the override bell crank.

The cinching lever can perform dual functions, cinching and ice breaking, fulfilling two distinct purposes and effectively reducing the number of components within the latch.

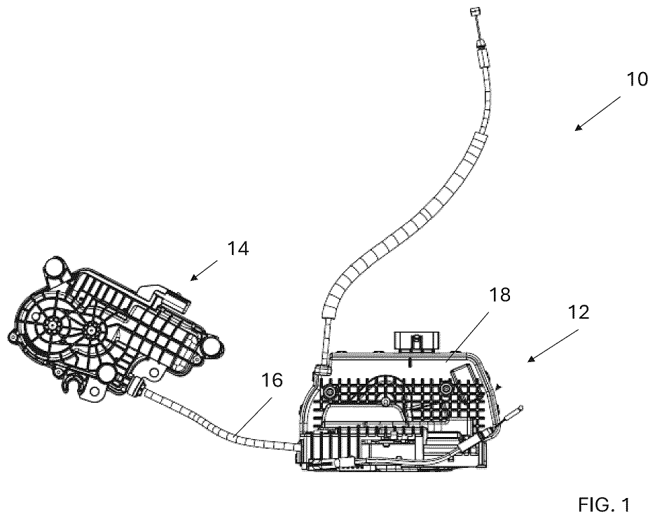

Referring now to FIG. 1, a vehicle latch assembly 10 is illustrated. The vehicle latch assembly 10 includes a vehicle latch 12 operably coupled to a remote cinching actuator 14 by a cable that is slidably received in a cable sheath 16 that extends from the vehicle latch 12 to the remote cinching actuator 14. In one non-limiting embodiment, the vehicle latch assembly 10 is configured for use with a side door of a vehicle.

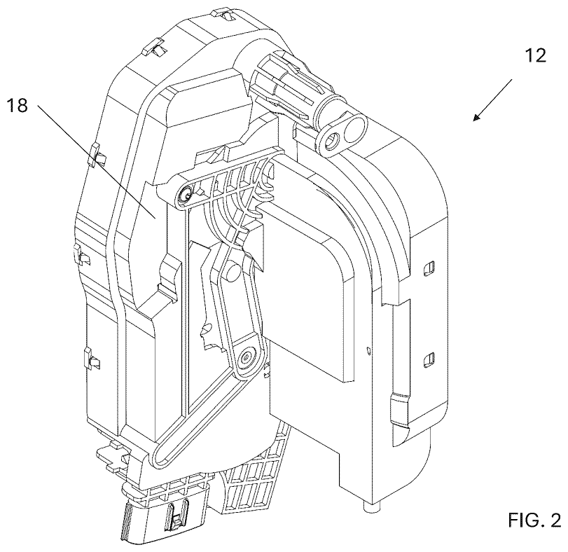

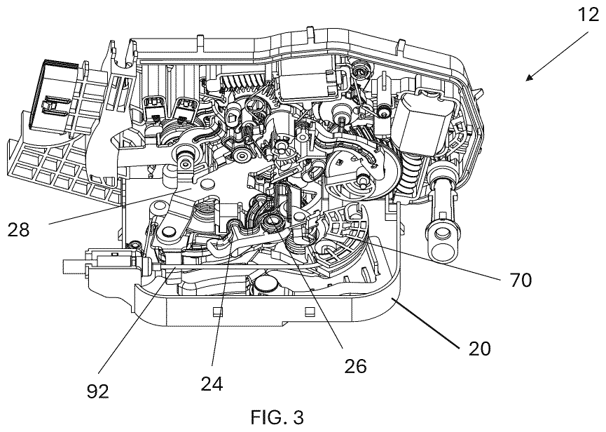

FIG. 2 illustrates the vehicle latch 12 and FIG. 3 illustrates the vehicle latch 12 with a cover 18 removed from a latch housing 20. FIG. 3 is a view of interior components of a vehicle latch in accordance with the present disclosure.

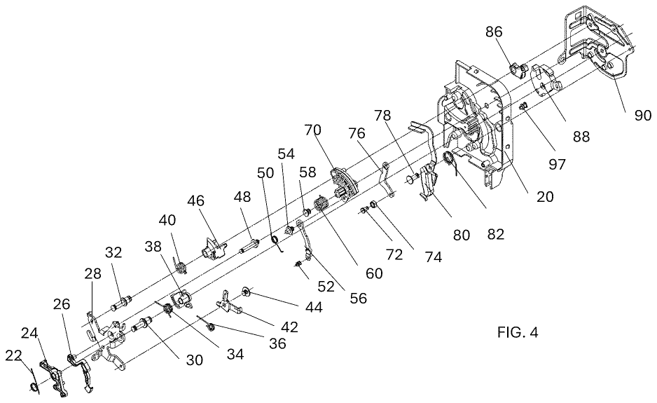

FIG. 4 is an exploded view of some interior components of the vehicle latch 12 in accordance with the present disclosure. As illustrated in at least FIG. 4 the following components are illustrated:
A Bellcrank Override Spring 22;
A Bellcrank Override Lever 24;
An Open Assist Clutch Lever 26;
A Backplate 28;
A Claw Pivot 30;
A Pawl Pivot 32;
A Cam Door Ajar Lever Spring 34;
An Override Clutch Lever Spring 36;
A Cam Door Ajar Lever 38;
A Pawl Spring 40;
An Override Clutch Lever 42;
An Override Clutch Lever Pivot 44;
A Pawl Lifter 46;
A Cinch Pivot 48;
An Open Assist Lever Spring 50;
An Open Assist Lever Guide Pivot 52;
An Open Assist Lever Pivot 54;
An Open Assist Lever 56;
A Cinch Link Pivot 58;
A Cinch Lever Spring 60;
A Cinch Lever 70;
A Bearing Pivot 72;
A Bearing 74;
A Cinch Link 76;
An Override Lever Pivot 78;
An Override Lever 80;
An Override Lever Spring 82;
A Latch Housing 20;
An Open Assist Pivot or feature 97;
A Pawl 86;
A Claw 88;
A Frame 90; and
A Cinch Cable 92.

FIG. 1 is a view of vehicle latch assembly in accordance with the present disclosure.

FIG. 2 is a perspective view of a vehicle latch in accordance with the present disclosure.

FIG. 3 is a view of interior components of a vehicle latch in accordance with the present disclosure.

FIG. 4 is an exploded view of some of the interior components of a vehicle latch in accordance with the present disclosure.

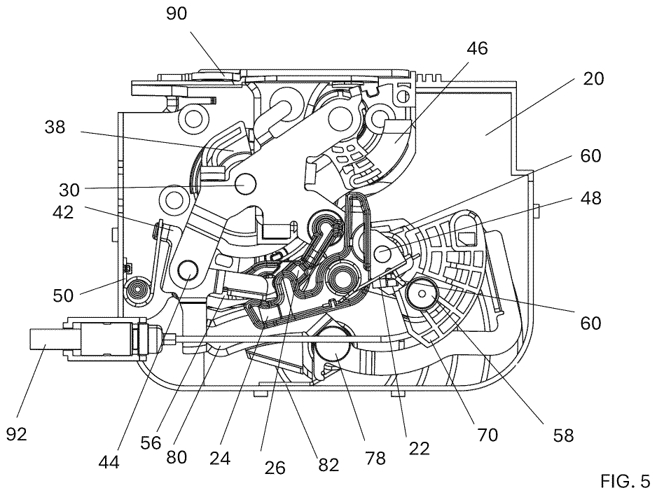

FIG. 5 is a view of interior components of a vehicle latch in accordance with the present disclosure.

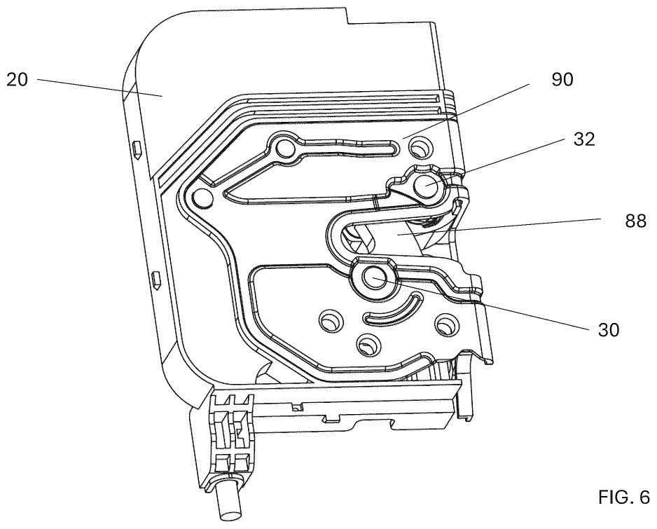

FIG. 6 is a perspective view of a housing of the vehicle latch in accordance with the present disclosure.

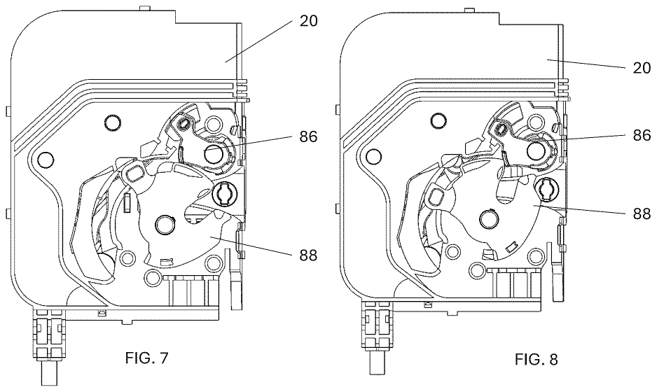

FIG. 7 is a view illustrating a claw and a pawl of the latch in an open position.

FIG. 8 is a view illustrating the claw and the pawl of the latch in a secondary position. FIGS. 7 and 8 illustrate the claw 88 transitioning from an open position (FIG. 7) to a closed position (FIG. 8).

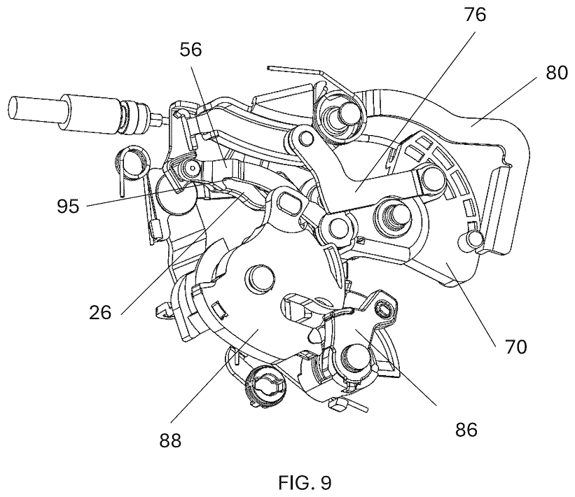

FIG. 9 illustrates components of the vehicle latch in the secondary position without the latch housing.

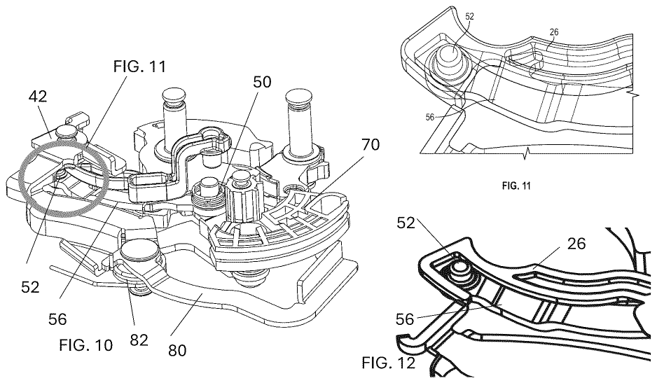

FIG. 10 illustrates components of the vehicle latch without the latch housing.

FIG. 11 is an enlarged portion of FIG. 10.

FIG. 12 is a cross-sectional view of FIG. 11.

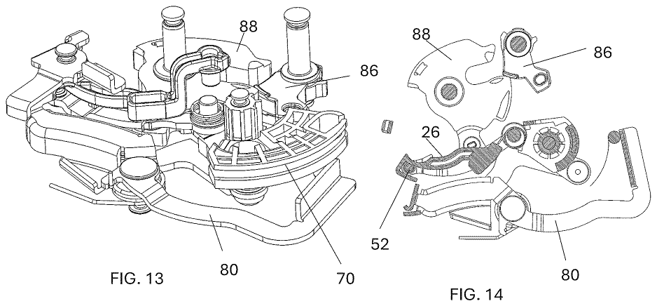

FIG. 13 illustrates components of the vehicle latch without the latch housing. FIG. 14 is a cross-sectional view of portions of FIG. 13. In at least FIGS. 13 and 14, the cinching mechanism of the vehicle latch is in a home position and at least FIG. 14 shows the open assist lever guide pivot 52 that rides along the open assist clutch lever 26.

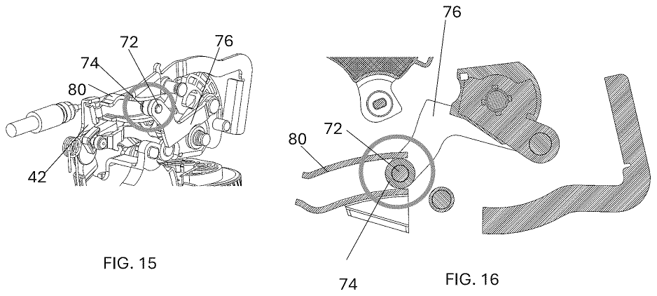

FIG. 15 illustrates components of the vehicle latch without the latch housing. FIG. 16 is a cross-sectional view of portions of FIG. 15. In at least FIGS. 15 and 16, bearing 74 is shown riding along a surface of the override lever 80.

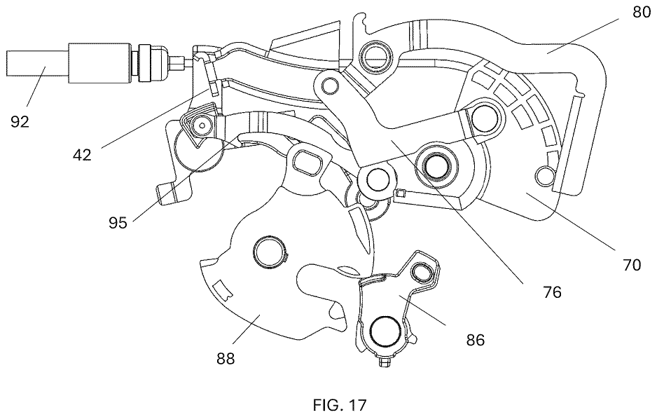

FIG. 17 illustrates a cinch mechanism of the vehicle latch in a home position.

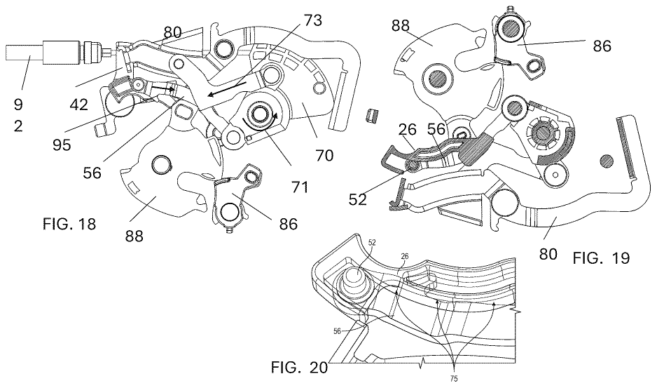

FIG. 18 illustrates operation of a cinch mechanism of the vehicle latch in accordance with the present disclosure. FIG. 19 is partial cross-sectional view of components illustrated in FIG. 18. FIG. 20 illustrates movement of components of the cinch mechanism in accordance with the present disclosure. Referring now to at least FIGS. 18-20 and as the remote cinching actuator energizes its cinch motor, the cinching cable 92 starts pulling the cinch lever 70, allowing the cinch lever 70 to move in the direction of arrow 71, consequently moving the cinch link 76 which is pivotally mounted on the cinch lever 70 in the direction of arrow 73, enabling the contact of the cinch link 76 to the claw 88, moving the latch from a secondary to a primary position (closed position).

While the latch is performing the cinch operation, the open assist lever guide pivot 52 rides along of a surface 75 located in the open assist clutch lever 26. This interaction allows the open assist lever 56 to bypass the open assist pivot or feature 97, avoiding a jamming condition between the open assist lever 56 and the claw 88 when the latch is moving from secondary to primary position.

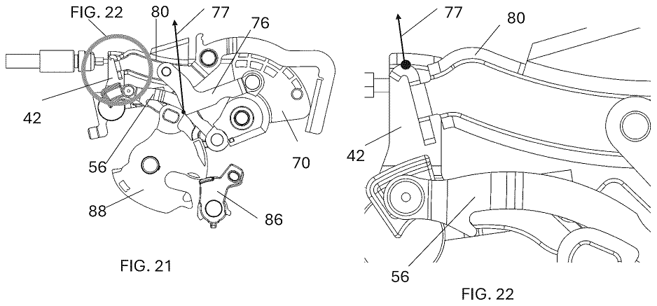

FIGS. 21 and 22 illustrate operation of a cinch mechanism of the vehicle latch in accordance with the present disclosure. Referring now to at least FIGS. 21 and 22, and as the cinching lever 70 transitions, a force vector in the direction of arrow 77 will be exerted to the override lever 80, that will support itself in the override clutch lever 42. This support makes possible the cinching path between the bearing 74 located on the cinch link 76 and in the override lever 80.

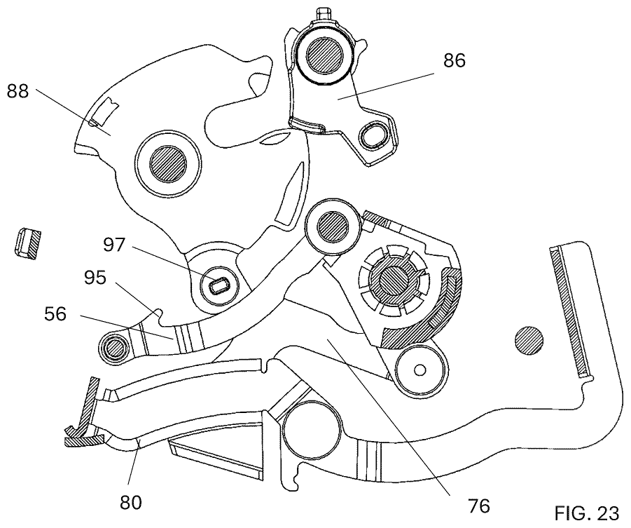

FIG. 23 illustrates components of the cinch mechanism in accordance with the present disclosure. In FIG. 23, the mechanism is in a home position and the mechanism is illustrated without open assist clutch lever 26.

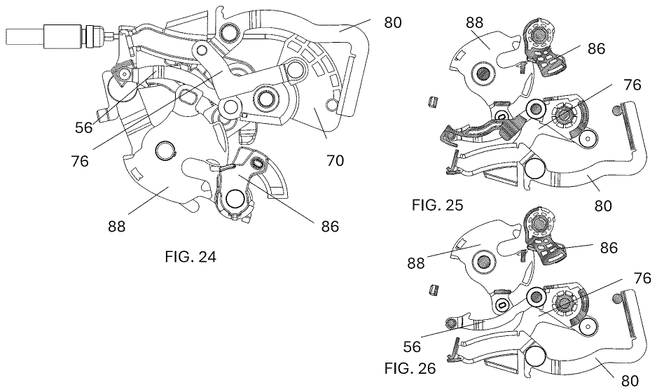

FIG. 24 illustrates the cinch mechanism in a home position in accordance with the present disclosure and FIGS. 25 and 26 are partial cross-sectional views of the view illustrated in FIG. 24.

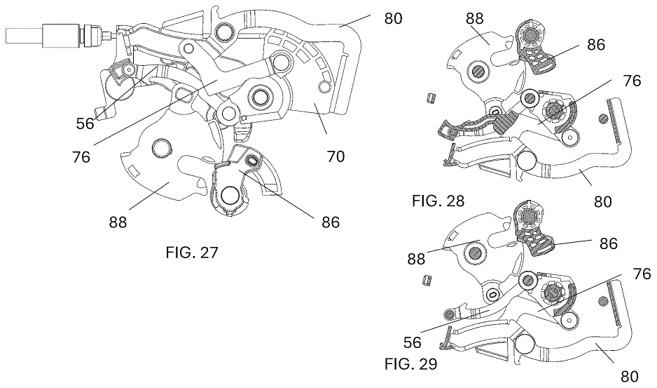

FIG. 27 illustrates the cinch mechanism in a first transition position or cinching transition 1 in accordance with the present disclosure. FIGS. 28 and 29 are partial cross-sectional views of the view illustrated in FIG. 27.

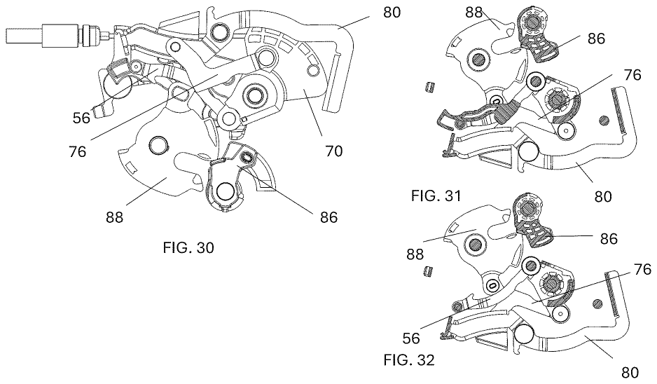

FIG. 30 illustrates the cinch mechanism in a second transition position or cinching transition 2 in accordance with the present disclosure.

FIGS. 31 and 32 are partial cross-sectional views of the FIG. 30.

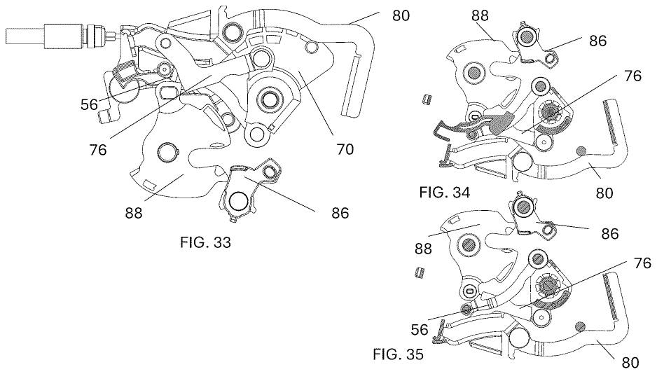

FIG. 33 illustrates the cinch mechanism in a third transition position or cinching transition 3 in accordance with the present disclosure.

FIGS. 34 and 35 are partial cross-sectional views of the FIG. 33.

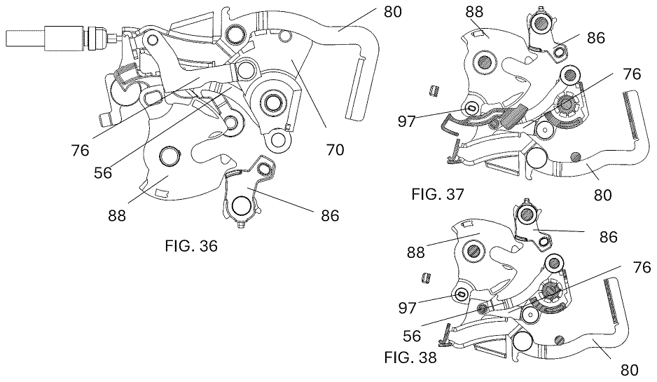

FIG. 36 illustrates the cinch mechanism in a full travel transition position in accordance with the present disclosure.

FIGS. 37 and 38 are partial cross-sectional views of the FIG. 36.

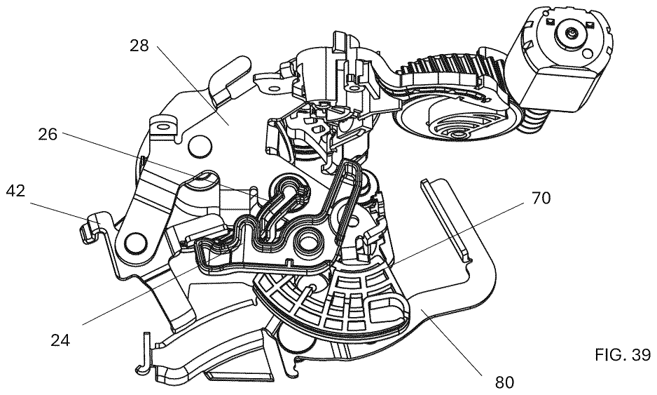

FIG. 39 illustrates the cinch mechanism in accordance with the present disclosure. The cinching operation shall be cancelled whenever there is a release scenario via power release or a manual release of the latch 12.

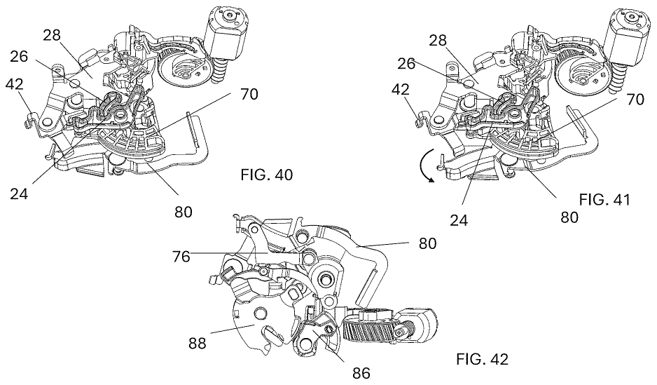

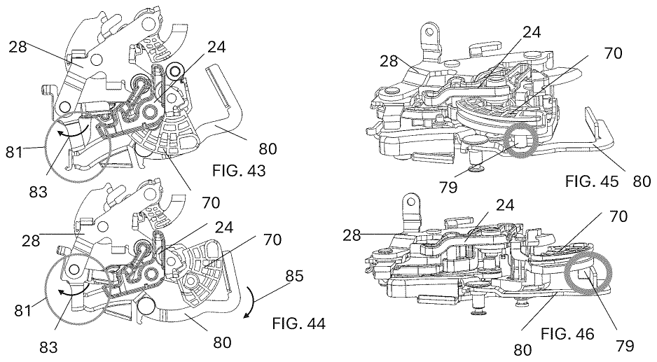

FIGS. 40-46 illustrates the override feature of the vehicle latch in accordance with the present disclosure. Referring now to at least FIGS. 40-42, and once the latch is released, the override lever 80 will lose the engagement with the override clutch lever 42 and will translate to the override position. This will consequently move the cinch link 76 also into the override position, allowing the claw 88 to rotate freely. When the cinch lever 70 is returning to its home position, it will also position the override lever 80 back to its home position. A cylinder 79 located in the cinch lever 70 will contact the override lever 80 on the cinch lever's way back to the home position, moving the override lever 80 to its home position. This will also return the override clutch lever 42 into its home position as shown by circles 81 and arrows 83. The movement of the override lever 80 back to its home position is illustrated by arrow 85.

FIGS. 47-53 illustrates the open assist feature of the vehicle latch in accordance with the present disclosure. Referring now to at least FIGS. 47-49 and whenever there is a release scenario, either power release or manual release, the latch 12 will detect a movement in the pawl 86 and the claw 88, by for example switches 101, 103 (illustrated schematically in at least in FIG. 49) located in the vehicle latch 12 to detect movement of the claw 88 and the pawl 86 in order to determine if the opening operation was successful. The switches 101 and 103 may be located in any position of the vehicle latch 12 in order to detect the desired movement of the claw 88 and pawl 86. The switches 101 and 103 are operably coupled to a controller, microcontroller or processor or other equivalent device 105 which controls the operation of the latch 12 as well as actuator 14. The switches in one non-limiting embodiment, may be configured to directly detect movement of the claw 88 and pawl 86. In case the latch 12 only senses the movement in the pawl 86, but not in the claw 88, (e.g., claw 88 has not rotated to the open position) the open assist mechanism will be triggered. In this case, the release mechanism will move the bellcrank override lever 24 and consequently, move the open assist mechanism. FIG. 47 illustrates the latch 12 in a home position. FIG. 48 illustrates a power release scenario and FIG. 49 illustrates a power release scenario when the claw 88 is stuck in a primary position while the pawl 86 is in a disengaged position.

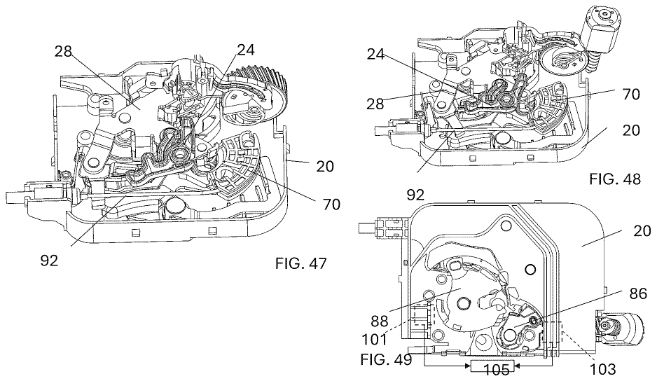

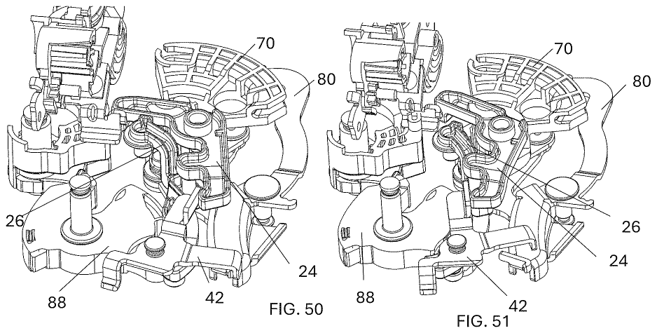

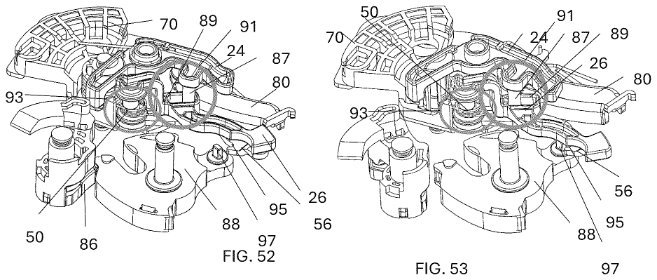

Referring now to at least FIGS. 50 and 51 and in this case, claw 88 is stuck in a primary position while the pawl 86 is in a disengaged position, the release mechanism will move the bellcrank override lever 24 and consequently, move the open assist mechanism. The release mechanism will also cancel the cinch operation whenever the latch 12 is cinching. Referring now to at least FIGS. 52 and 53, and whenever a release scenario is actuated, the bellcrank override lever 24 will consequently move the open assist clutch lever 26 into an “engaged position”. This is due to a cylindrical feature 87 that is located on the bellcrank override lever 24 and enclosed into a channel 89 in the open assist clutch lever 26. See the circled area 91. When the bellcrank override lever 24 moves the open assist clutch lever 26, it will allow the open assist lever 56 to fall into an “engage” position with the claw 88. The open assist lever 56 will move to the engage position also due to the open assist lever spring 50, as enclosed by circle 93. As shown, the open assist lever 56 has a channel or opening 95 configured to engage a feature or pivot 97 of the claw 88.

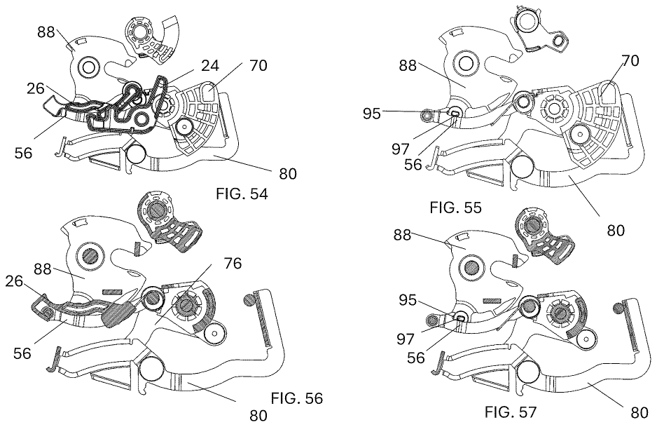

FIGS. 54 and 55 illustrate the vehicle latch in the release position with the open assist enabled and FIGS. 56 and 57 are partial cross-sectional views of illustrated in FIGS. 54 and 55.

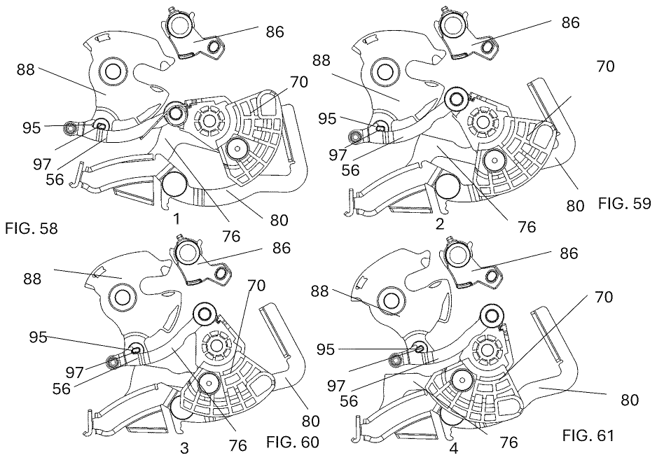

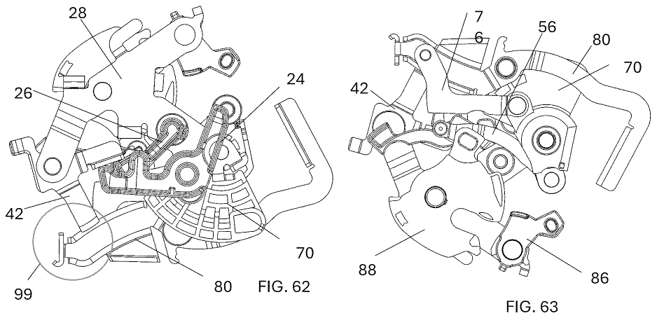

FIGS. 58-61 illustrate opening assist transitions of the vehicle latch 12 in accordance with the present disclosure. FIG. 58 illustrates a first opening transition. FIG. 59 illustrates a second opening transition after the first opening transition. FIG. 60 illustrates a third opening transition after the second opening transition and FIG. 61 illustrates a fourth opening transition after the third opening transition. FIGS. 62 and 63 illustrate operation of the open assist in accordance with the present disclosure. When the open assistant is operating, the cinching mechanism is deactivated because the override lever 80 does not have a support with the override clutch lever 42 (as shown by circle 99). This will deactivate the cinch function whenever the open assist is functioning.

As used herein and as known in the related arts, a primary position of the claw 88 refers to a closed position of the vehicle latch 12 wherein the claw 88 retains a striker (not shown) and the door the vehicle latch 12 is associated with is fully closed and the pawl 86 is in an engaged position that retains the claw 88 in the closed or primary position. As used herein and as known in the related arts, the open position of the vehicle latch 12 refers to a position where the claw 88 no longer retains the striker and the door the vehicle latch 12 is associated with is open or openable and the pawl 86 has been moved to a disengaged position so that the claw 88 can rotate from the closed or primary position to the open position. As used herein and as known in the related arts, the secondary position refers to a partially closed position of the vehicle latch 12 wherein the claw 88 retains the striker and the door the vehicle latch 12 is associated with is partially closed and the pawl 86 is in an engaged position that retains the claw 88 in the secondary position.

As such, the vehicle latch 12 is configured to perform a motorized cinching operation wherein the claw 88 is pushed from the secondary position to the primary or closed position.

When a cinching operation has begun, the cinching operation may be referred to as when a rotational force is applied to the cinching lever 70 by cinch cable 92 that is secured to the cinching lever 70 at one end and a drum (not shown) of the remote cinching actuator 14 that is driven or rotated by a motor (not shown) of the remote cinching actuator 14 such that the cable 92 is wind upon the drum and the cinching lever 70 is rotated. During this movement, the cinch link 76 contacts a surface of the claw 88. As such, the cinch link 76 will rotate the claw 88 into the primary or fully latched position illustrated. In this position, the pawl 86 will retain the claw 88 in the primary or fully latched position.

In one non-limiting embodiment of the present disclosure and for providing the power assist for opening of the vehicle latch 12, the actuation of the remote cinching actuator 14 only occurs when the pawl 86 is in the disengaged position and the claw 88 is still in at least the primary or closed position as such, the remote cinching actuator 14 will be activated and the open assist lever 56 will contact the feature 97 of the claw 88 via opening or channel 95 and push it or pull it from the primary position or alternatively the secondary position towards the open position. The activation of the remote cinching actuator 14 will occur when a first switch determines that the pawl 86 is in the disengaged position and a second switch determines that the claw 88 is still in the primary position or alternatively the secondary position. The first switch and the second switch are each operably coupled to a controller that is operably coupled to a motor of the remote cinching actuator 14.

Accordingly, the remote cinching actuator 14 may perform two functions 1) where the claw 88 is cinched closed into the primary position from the secondary position or 2) where the claw is pushed open from the primary position both of which are achieved by rotating the cinching lever 70 in the same direction by the remote cinching actuator 14 however two distinct functions are capable of being performed through the rotation of the cinching lever 70 by the remote cinching actuator 14 as at least the open assist lever 56 and the cinch link 76 are appropriately positioned depending on the operation desired (e.g., open assist or cinching) while the cinching lever 70 is rotated by the remote cinching actuator 14.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A vehicle latch assembly (10), comprising:
a remote cinching actuator (14); and
a vehicle latch (12), the vehicle latch comprising:
a latch housing (20);
a claw (88) pivotally mounted to the latch housing;
a cinch lever (70) pivotally mounted to the latch housing, wherein rotation of the cinch lever by the remote cinching actuator will rotate the claw into a closed position or rotate the claw into an open position; and
an open assist lever (56) pivotally secured to the cinch lever (70) the open assist lever (56) has a channel (95) configured to engage a feature (97) of the claw (88) of the vehicle latch.

2. The vehicle latch assembly (10) as in claim 1, wherein the vehicle latch (12) further comprises:
an open assist clutch lever (26) and wherein the open assist lever (56) has a guide pivot (52) operably coupled to the open assist clutch lever (26).

3. The vehicle latch assembly (10) as in claim 2, wherein the vehicle latch (12) further comprises:
a bellcrank override lever (24) operably coupled to the open assist clutch lever (26).

4. The vehicle latch assembly (10) as in claim 3, wherein the vehicle latch (12) further comprises:
a cinch link (76) pivotally secured to the cinch lever (70), the cinch link (76) contacting the claw (88) during a cinching operation of the vehicle latch (12).

5. The vehicle latch assembly (10) as in claim 4, wherein the cinch link (76) further comprises a bearing (74) that makes contact with an override lever (80) of the vehicle latch (12).

6. The vehicle latch assembly (10) as in claim 4, wherein rotation of the cinch lever (70) during a cinching operation causes the cinch link (76) to contact the claw (88) and rotate the claw into the closed position.

7. The vehicle latch assembly (10) as in claim 4, wherein rotation of the cinch lever (70) during an open assist operation causes the cinch link (76) to not contact the claw (88) and the open assist lever (56) will engage the feature (97) of the claw (88) via the channel (95) of the open assist lever (56) in order to rotate the claw (88) into the open position.

8. The vehicle latch assembly (10) as in claim 7, wherein the cinch link (76) further comprises a bearing (74) that makes contact with an override lever (80) of the vehicle latch (12).

9. The vehicle latch assembly (10) as in claim 8, wherein rotation of the cinch lever (70) during a cinching operation causes the cinch link (76) to contact the claw (88) and rotate the claw (88) into the closed position and the open assist lever (56) does not contact the claw (88).

10. A vehicle latch (12), the vehicle latch comprising:
a latch housing (20);
a claw (88) pivotally mounted to the latch housing;
a cinch lever (70) pivotally mounted to the latch housing, wherein rotation of the cinch lever will rotate the claw into a closed position or rotate the claw into an open position; and
an open assist lever (56) pivotally secured to the cinch lever (70) the open assist lever (56) has a channel (95) configured to engage a feature (97) of the claw (88) of the vehicle latch.

11. The vehicle latch (12) as in claim 10, further comprising:
an open assist clutch lever (26) and wherein the open assist lever (56) has a guide pivot (52) operably coupled to the open assist clutch lever (26).

12. The vehicle latch (12) as in claim 11, further comprising:
a bellcrank override lever (24) operably coupled to the open assist clutch lever (26).

13. The vehicle latch (12) as in claim 12, further comprising:
a cinch link (76) pivotally secured to the cinch lever (70), the cinch link (76) contacting the claw (88) during a cinching operation of the vehicle latch (12).

14. The vehicle latch (12) as in claim 13, wherein the cinch link (76) further comprises a bearing (74) that makes contact with an override lever (80) of the vehicle latch (12).

15. The vehicle latch (12) as in claim 13, wherein rotation of the cinch lever (70) during a cinching operation causes the cinch link (76) to contact the claw (88) and rotate the claw into the closed position.

16. The vehicle latch (12) as in claim 13, wherein rotation of the cinch lever (70) during an open assist operation causes the cinch link (76) to not contact the claw (88) and the open assist lever (56) will engage the feature (97) of the claw (88) via the channel (95) of the open assist lever (56) in order to rotate the claw (88) into the open position.

17. The vehicle latch (12) as in claim 16, wherein the cinch link (76) further comprises a bearing (74) that makes contact with an override lever (80) of the vehicle latch (12).

18. The vehicle latch (12) as in claim 17, wherein rotation of the cinch lever (70) during a cinching operation causes the cinch link (76) to contact the claw (88) and rotate the claw (88) into the closed position and the open assist lever (56) does not contact the claw (88).

19. A method of opening and closing a vehicle latch (12) of a vehicle latch assembly (10), comprising:
actuating a remote cinching actuator (14) of the vehicle latch assembly (10) during an open assist operation of the vehicle latch (12) when a pawl (86) of the vehicle latch (12) is in a disengaged position with respect to a claw (88) of the vehicle latch (12) and the claw (88) of the vehicle latch (12) is in a closed position;
actuating the remote cinching actuator (14) of the vehicle latch assembly (10) during a cinching operation of the vehicle latch (12) in order to rotate the claw (88) of the vehicle latch (12) into the closed position;
wherein actuation of the remote cinching actuator (14) during the cinching operation of the vehicle latch (12) or the open assist operation of the vehicle latch (12) causes a cinch lever (70) of the vehicle latch (12) to rotate in a first direction;
wherein rotation of cinch lever (70) in the first direction during the cinching operation of the vehicle latch (12) will cause a cinch link (76) pivotally secured to the cinch lever (70) to contact the claw (88) and rotate the claw (88) into the closed position;
wherein rotation of cinch lever (70) in the first direction during the open assist operation of the vehicle latch (12) will cause an open assist lever (56) pivotally secured to the cinch lever (70) to engage a feature (97) of the claw (88) of the vehicle latch (12) with a channel or opening (95) of the open assist lever (56); and
wherein the open assist lever (56) does not contact the claw (88) during the cinching operation of the vehicle latch (12) and the cinch link (76) does not contact the claw (88) during the open assist operation of the vehicle latch (12).

20. The method as in claim 19, wherein the open assist lever (56) has a guide pivot (52) operably coupled to an open assist clutch lever (26) of the vehicle latch (12) and the cinch link (76) further comprises a bearing (74) that makes contact with an override lever (80) of the vehicle latch (12), the guide pivot (52) determining a position of the open assist lever (56) and the bearing (74) determining a position of the cinch link (76).
